(19) United States
(12) Patent Application Publication
(10) Pub. No.: US 2016/0053816 A1
(43) Pub. Date: Feb. 25, 2016

(54) CENTRIFUGAL PENDULUM

(71) Applicant: Schaeffler Technologies AG & Co. KG, Herzogenaurach (DE)

(72) Inventors: Peter Wahl, Woerth-Maximiliansau (DE); Benjamin Voegtle, Karlsruhe (DE)

(21) Appl. No.: 14/780,953

(22) PCT Filed: Mar. 19, 2014
(86) PCT No.: PCT/DE2014/200130

§ 371 Date: Sep. 28, 2015

(30) Foreign Application Priority Data
Apr. 2, 2013 (DE) 10 2013 205 802.0
Apr. 8, 2013 (DE) 10 2013 005 872.4
Apr. 8, 2013 (DE) 10 2013 206 155.2
Dec. 6, 2013 (DE) 10 2013 225 060.6
Feb. 19, 2014 (DE) 10 2014 203 012.9
Feb. 19, 2014 (DE) 10 2014 203 016.1

(51) Int. Cl. F16D 3/12; F16F 15/129; F16D 3/14; F16F 15/123

(52) U.S. Cl. CPC F16D 3/12; F16F 15/12366; F16F 15/129; F16D 3/14

(57) ABSTRACT

A torque transfer device includes a drive element, an output element, an elastic element for coupling the drive element with the output element, a first pendulum mass which is movably attached to the pendulum flange in the plane of rotation, and a second pendulum mass which is movably attached to the pendulum flange in the plane of rotation. At the same time, at least one of the pendulum masses is matched to different orders of excitation of the rotary motion of the drive element.

The invention relates to a centrifugal pendulum. In particular, the invention relates to a centrifugal pendulum for the drivetrain of a motor vehicle having a reciprocating internal combustion engine.

### BACKGROUND

In a drivetrain of a motor vehicle, a drive motor is provided which provides a torque that is transmitted to drive wheels of the motor vehicle by means of the drivetrain. The rotary motion may be subject to a non-uniformity. This rotational non-uniformity may come in particular from the fact that the drive motor comprises a reciprocating internal combustion engine, which, due to its principle does not deliver completely uniform torque. However, non-uniformities may also be provoked by the drivetrain itself, or may be coupled into the drivetrain through the drive wheels.

To eliminate rotational non-uniformities, in particular torsional vibrations, a centrifugal pendulum may be provided in the drivetrain. The centrifugal pendulum comprises a pendulum flange having an axis of rotation and a pendulum mass which is movably attached to the axis of rotation in the plane of rotation. If the rotary motion of the pendulum flange is accelerated or decelerated, the pendulum mass is moved relative to the pendulum flange. The pendulum mass is held on a pendulum path, which changes the effective distance of the pendulum mass from the axis of rotation when the pendulum mass is deflected. This enables rotary energy to be temporarily stored briefly in the pendulum mass. Rotational non-uniformities of all types can be inhibited effectively thereby.

The centrifugal pendulum must be designed for a frequency, or frequency range, in which it is able to eliminate rotational non-uniformities. However, in a modern motor vehicle, rotational non-uniformities may occur which overtax a conventional centrifugal pendulum. For instance, shutting down individual cylinders of the reciprocating internal combustion engine, for example from 8 to 4, from 6 to 3 or from 4 to 2 cylinders, can widen the frequency band in which rotational non-uniformities or torsional vibrations may be expected. A normal centrifugal pendulum, which is designed for only one order of matching, may come up against the limits of vibration isolation due to physical limits, in particular in the rolling contact of the pendulum mass on the pendulum flange by means of a sliding block guide. It is often not possible to design the centrifugal pendulum for two different orders of matching, so that comprehensive elimination of vibrations cannot be achieved even by optimizing the design.

### SUMMARY OF THE INVENTION

It is an object of the present invention to provide an improved centrifugal pendulum that can be matched to two different orders of matching. The invention fulfills this object by means of a centrifugal pendulum having the features of the independent claim. Subordinate claims describe preferred embodiments.

The present invention provides a torque transfer device for transmitting a torque between a drive element and an output element, comprising a torsional vibration damper having at least one damper stage, comprising a damper input part and a damper output part coupled therewith through a damper stage having energy storage elements, and a first and a second centrifugal pendulum device.

The first and second centrifugal pendulum devices may be matched to different or the same orders of excitation of the drive element. The pendulum length and/or the pendulum mass and/or the pendulum radius preferably varies between the first and second centrifugal pendulum devices. The drive element may be designed as an internal combustion engine, or may be intended for connecting to an internal combustion engine.

The centrifugal pendulum device may be connected detachably or firmly to the torsional vibration damper. It can also be possible to couple the centrifugal pendulum device to a component of the torque transfer device, enabling limited rotatability between the centrifugal pendulum device and that component. This limited rotatability may preferably be effected by means of coupling elements, in particular elastic coupling elements. The following specific embodiments of the invention are proposed in reference to the torsional vibration damper:

A torsional vibration damper having one damper stage, comprising a damper input part and a damper output part coupled therewith by means of a first damper stage having energy storage elements.

A torsional vibration damper having at least two damper stages connected in series, comprising a damper input part and a damper intermediate part coupled therewith by means of a first damper stage having first energy storage elements, and a damper output part coupled therewith by means of a second damper stage having second energy storage elements.

In both the single-stage and the multi-stage torsional vibration damper, there can again be energy storage elements connected in parallel within a damper stage. A clearance angle may preferably be provided in the arrangement of at least one energy storage element, up to which the energy storage element is not compressed, but rather only when the clearance angle has been reached and surpassed. In special forms of the invention, at least one energy storage element may be a coil spring, in particular a bow spring or compression spring. Combinations of these spring types are also conceivable. The specific types of torsional vibration damper named above may be combined with the following specific variant arrangements of the centrifugal pendulum devices:

Positioning of the first and second centrifugal pendulum devices in the power stream before the damper stage and/or in the power stream after the damper stage. In the case of a multi-stage torsional vibration damper, the first and second centrifugal pendulum devices may be positioned in the power stream before the first damper stage and/or in the power stream after the first damper stage, especially in the power stream after the second and/or additional damper stage.

The first and second centrifugal pendulum devices may be attached jointly to a component, preferably to a damper component. The first and second centrifugal pendulum devices may also each be attached to different components, in particular each to a damper component. The first and second pendulum devices may also be positioned at the same or at different radii, and/or axially in the same or in different planes.

The invention also includes a torque transfer device such as a hydrodynamic torque converter, and/or a torsional vibration damper, and or a wet-running or dry-running clutch device, and/or a dual-mass flywheel having a centrifugal pendulum device according to one or more of the embodiments explained above.

A torque transfer device according to the invention comprises a drive element, an output element, an elastic element for coupling the drive element with the output element, a pendulum flange which is connected to the output element, a first pendulum mass which is movably attached to the pendulum flange in the plane of rotation, and a second pendulum mass which is movably attached to the pendulum flange in the plane of rotation. At the same time, at least one of the pendulum masses is matched to different orders of excitation of the rotary motion of the drive element.

For matching to a plurality of orders of matching, a pendulum mass may comprise a first pendulum element and a second pendulum element, which can then each be designed for an order of matching, independently of each other. The matching can then take place, for example, by means of the effective radii, the masses or the path curves of the individual pendulum masses or pendulum elements. In particular, it is preferred that the first and second pendulum masses are each matched to a first order of matching, and that in addition one of the pendulum masses is matched to a second order of matching.

The drive element can be connected to a rotatable shaft, where the shaft transmits torque into a drivetrain. In this sense, an output element of the centrifugal pendulum may coincide with the input side. In a different embodiment, the input element and the output element are provided separately from each other.

In this case, the pendulum flange is attached rotatably around the axis of rotation relative to the drive element, and an elastic element is provided to couple the pendulum flange with the drive element. The elastic element may be in particular a compression spring or bow spring. This enables the working range of the centrifugal pendulum to be extended or adapted. The adaptation can be determined, in particular, by the spring rate, the spring travel and the effective radius of the pendulum masses around the axis of rotation. In one embodiment, the elastic element can also be damped so as to attenuate a compression or expansion with a damping force, in particular a frictional force.

A second pendulum flange may be provided, to which the second pendulum mass is attached movably in the plane of rotation, where the second pendulum flange is attached rotatably in the plane of rotation around the axis of rotation relative to the first pendulum flange and an elastic element is provided to couple the second pendulum flange with the first pendulum flange.

In one embodiment, sections of the pendulum flange or flanges to which the pendulum masses are attached are offset. In other words, the first pendulum mass may be offset axially relative to the second pendulum mass. At the same time, both pendulum masses may again be replaced by pairs of pendulum masses, which are assigned to the same or different orders of matching.

In a first variant of the axially offset configuration, a first section to which the first pendulum mass is attached and a second section to which the second pendulum mass is attached are frictionally engaged with each other on a radial outer side. In this way, the first and second pendulum masses are connected to each other in a U-shape. As described previously, elastic elements may be provided, independently of each other, between the drive element and the first pendulum flange and between the first and second pendulum flanges. Furthermore, the first and second pendulum flanges may again be replaced with pairs of pendulum masses, as explained in greater detail above.

In a first variant, a first section to which the first pendulum mass is attached and a second section to which the second pendulum mass is attached are frictionally engaged with each other on a radial inner side. The pendulum flanges may again form a U-shaped structure which, in contrast to the variant described above, is open radially to the outside. Here too, the pendulum masses may be replaced with pairs of pendulum masses, as described above. Furthermore, both pendulum masses may be mounted opposite the drive element independently of each other by means of elastic elements. In one embodiment, in each case an elastic element may or may not be provided between each of the sections and a connecting section.

The connecting element may be rotatably attached around the axis of rotation relative to the drive element, in which case an elastic element is provided to couple the connecting section with the drive element. In this way, the pendulum masses can be uncoupled from each other by up to two elastic elements, and a transmission of power can run between the drive element and each of the pendulum flanges through up to two elastic elements. This results in multiple possibilities for matching the two pendulum masses to the same or different orders of matching. As before, in this embodiment too both pendulum masses may be replaced with pairs of pendulum masses, independently of each other.

In general, the pendulum masses may be attached around the axis of rotation alternatively with the same or different effective radii. Furthermore, the pendulum masses used may be designed for the same or different orders of matching.

### BRIEF DESCRIPTION OF THE DRAWINGS

The invention will now be described in greater detail by reference to the accompanying figures, where the figures depict the following:

FIGS. 1-4 schematic depictions of embodiments of torque transfer devices;

FIGS. 5-6 a first embodiment of a torque transfer device;

FIGS. 7-9 a second embodiment of a torque transfer device;

FIGS. 10-11 a third embodiment of a torque transfer device;

FIGS. 12-13 a fourth embodiment of a torque transfer device;

FIGS. 14-15 a fifth embodiment of a torque transfer device;

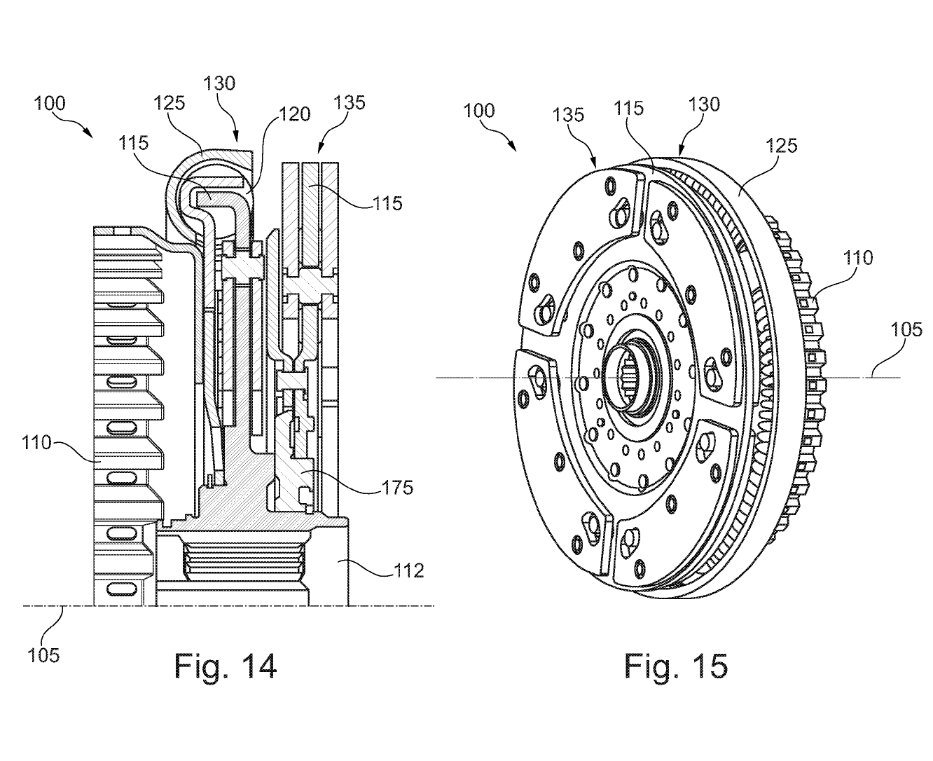

FIGS. 16-17 a sixth embodiment of a torque transfer device;

FIGS. 18-19 a seventh embodiment of a torque transfer device, and

FIGS. 20-21 an eighth embodiment of a torque transfer device.

### DETAILED DESCRIPTION

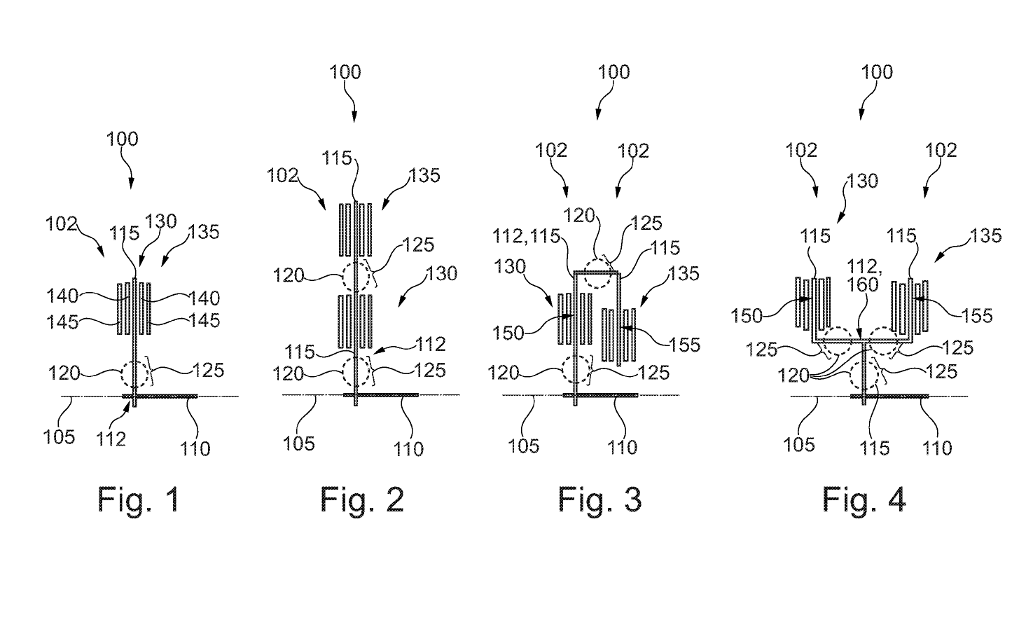

FIG. 1 shows a schematic depiction of an embodiment of a torque transfer device 100 having a centrifugal pendulum 102. A drive element 110 is situated so that it can rotate around an axis of rotation 105. The centrifugal pendulum 102 includes a pendulum flange 115, which is connected to the drive element 110 and extends from the axis of rotation 105 in the radial direction. Torsionally connected to the pendulum flange 115 is an output element 112, which is likewise rotatably mounted around the axis of rotation 105. In one embodiment, the pendulum flange 115 is mounted rotatably in relation to the drive element 110, and an elastic element 120 acts on a circumference around the axis of rotation 105 between the pendulum flange 115 and the drive element 110, in order to convey rotary motions around the axis of rotation 105. The elastic element 120 may be, in particular, a straight spring or bow spring. Furthermore, a damping element 125 may be provided in order to attenuate the relative rotary motion by friction. The damping element 125 may work in particular together with the elastic element 120. In addition, in various embodiments the damping element 120 may comprise a plurality of individual elements which are coupled with each other in series or in parallel.

Furthermore, the centrifugal pendulum 102 includes a first pendulum mass 130 and a second pendulum mass 135, which are movably attached to the pendulum flange 115. The first pendulum mass 130 and the second pendulum mass 135 may be designed for the same orders of matching (q1) or orders of excitation, or for different orders of matching (q1 and q2). To design the order of matching of a pendulum mass 130, 135, its mass, its effective radius relative to the axis of rotation 105 or its pendulum path may be influenced. In one embodiment, the first pendulum elements 140 are designed for an order of matching of 2.0 and the second pendulum elements 145 are designed for an order of matching of 1.0.

Preferentially, both pendulum masses 130, 135 have the same effective radius in reference to the axis of rotation 105, and are located on a common component of the torque transfer device 100. Preferably, the common component is that of a torsional vibration damper, which includes an elastic element 120 operating in the circumferential direction around the axis of rotation. The torsional vibration damper may have one or more damper stages.

If a pendulum mass 130 or 135 is to be matched to multiple orders of matching, the pendulum mass 130, 135 can be divided into a first pendulum element 140 and a second pendulum element 145, which are each attached movably to the pendulum flange 115 and matched to a predetermined order of matching. In different embodiments, the first and second pendulum elements 140, 145 may be positioned as shown axially or offset on a circumference around the axis of rotation 105. Seen on the circumference, a plurality of first pendulum elements 140 may be combined in a first, and a plurality of second pendulum elements 145 may be combined in a second pendulum mass group. Each pendulum element 140, 145, or each pendulum mass group, is then matched to a predetermined order of matching. For example, the first pendulum mass 130 may be matched to a first order of matching (q1), while the second pendulum mass 135 comprises the first pendulum element 140, which is matched to a second order of matching (q2), and the third pendulum element 145, which is matched to a third order of matching (q3). It is particularly preferred here that the first (q1) and the third order of matching (q3) coincide. The first order of matching (q1) may correspond to an operation using all cylinders of a reciprocating-piston combustion engine which is connected to the drive element 110, while the second order of matching corresponds to operation with a reduced number of cylinders. This makes it easier to shut off cylinders of the combustion engine.

FIG. 2 shows an alternative embodiment of the torque transfer device 100 of FIG. 1. In contrast to the embodiment depicted in FIG. 1, the first pendulum mass 130 and the second pendulum mass 135 are positioned radially offset on the pendulum flange 115. Each pendulum mass 130, 135 may be designed for one or two different orders of matching, as described above.

The spring element 120 and the damping element 125, which were already described above in greater detail, may also be employed in this embodiment. Independently thereof, the pendulum flange 115 may also be interrupted in a radial region between the first pendulum mass 130 and the second pendulum mass 135, in which case another elastic element 120 is provided so as to couple the two resulting pendulum flanges 115 with each other rotatably around the axis of rotation 105.

The pendulum masses 130, 135 may each be designed for one order of matching (q1) or for two orders of matching (q1 and q2). Preferentially, the two pendulum masses 130 and 135 have different effective radii in reference to the axis of rotation 105.

FIG. 3 shows another embodiment of the torsion transfer device 100, which differs from the embodiment shown in FIG. 2 chiefly in the fact that the pendulum masses 130 and 135 are offset axially from each other. Here too, the pendulum masses 130, 135 may each be designed for one order of matching (q1) or for two orders of matching (q1 and q2). In the sectional view shown, the pendulum flange or flanges 115 form a U-shaped structure which is open on the radially inner side. The first pendulum mass 130 is attached to a first section 150 and the second pendulum mass 135 to a second section 155 on the pendulum flange 115. Both pendulum masses 130 and 135 may have the same or different effective radii around the axis of rotation 105. The elastic elements 120 and also the damping elements 125 are both optional.

FIG. 4 shows yet another embodiment of the torque transfer device 100 from FIGS. 1 through 3. Similarly to the embodiment depicted in FIG. 3, the pendulum masses 130 and 135 are offset from each other axially, while they may occupy the same or different effective radii in reference to the axis of rotation 105. The pendulum flange 115 again forms a U-shaped structure, which, in this case, however is open on the radially outer side. The first section 150, to which the first pendulum mass 130 is attached, and the second section 155, to which the second pendulum mass 135 is attached, are frictionally engaged with each other on the radially inner side of the pendulum masses 130, 135. The pendulum masses 130 and 135 may be matched to the same (q1) or different orders of matching (q1 and q2). Between a connecting section 160 and each of the sections 150, 155 an elastic element may be situated, optionally having a damping element 125. Another elastic element 120 may be provided between the connecting section 160 and the drive element 110. Otherwise, the possible variations of the individual elements described above in reference to FIG. 1 through 3 exist in the embodiment shown in FIG. 4.

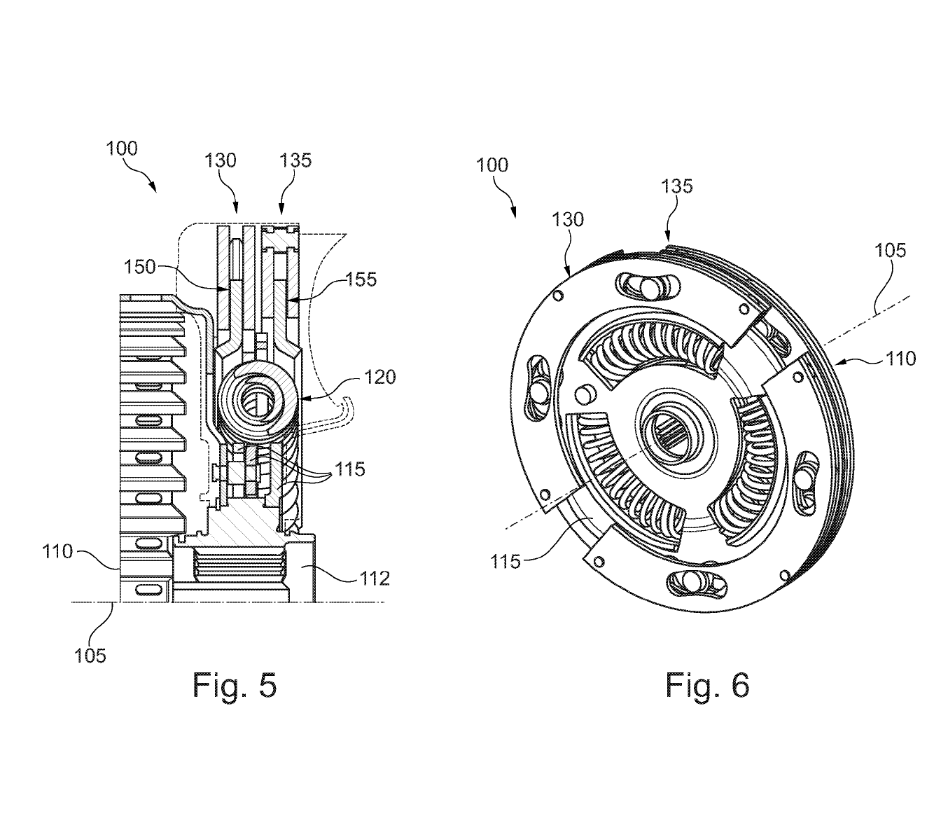

FIGS. 5 and 6 show a first embodiment of a torque transfer device 100 according to the embodiment of FIG. 4. The drive element 110 is formed by way of example by a clutch bell housing, which may be connected to a turbine of a hydrodynamic torque converter. The pendulum flanges 115, which are offset from each other axially, are each braced by means of the elastic element 120 with respect to the radially middle pendulum flange 115, which is connected directly to the drive element 110. The first pendulum masses 130 and 135 may again be matched to the same or different orders of matching.

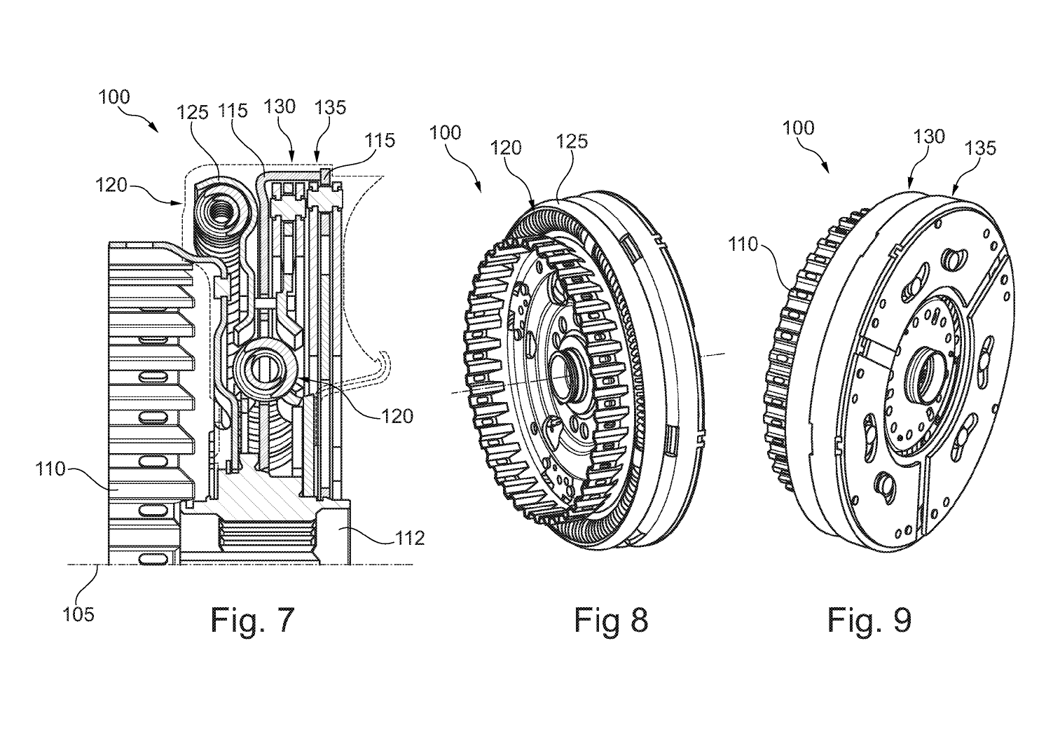

FIGS. 7 and 9 show a second embodiment of the torque transfer device 100 according to the schematic diagram of the embodiment of FIG. 3. The pendulum masses 130 and 135 are offset from each other axially. The pendulum flange 115 of the second pendulum mass 135 is connected to the drive element 110 by means of a radially inner first elastic element 120 and a radially outer second elastic element 120. The pendulum flange 115 of the first pendulum mass 130, on the other hand, is connected to the drive element 110 only by means of the second elastic element 120. The second pendulum mass 135 is thus connected tertiarily and the first pendulum mass 130 secondarily.

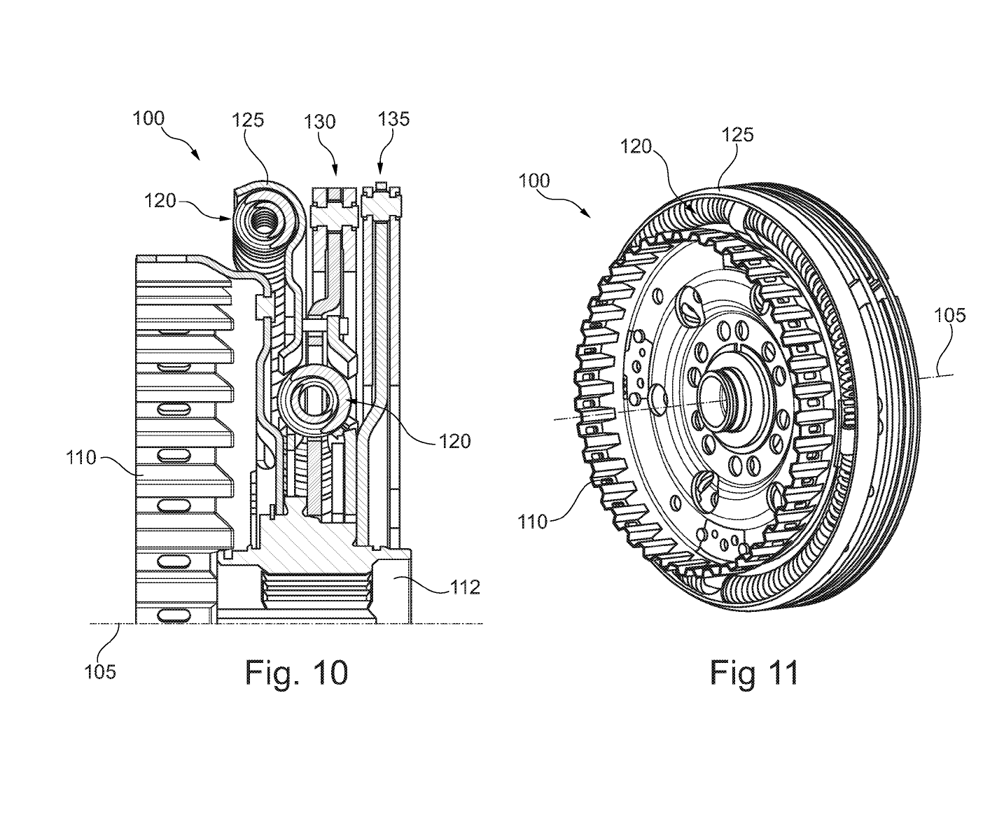

FIGS. 10 and 11 show a third embodiment of a torque transfer device 100 according to the embodiment of FIG. 4. Here, the first pendulum mass 130 is connected to the output element 112 by means of the radially inner first elastic element 120 and the radially outer second elastic element 120. The second pendulum mass 135 is connected through the output element 112 to the drive element 110 only by means of the second elastic element 120.

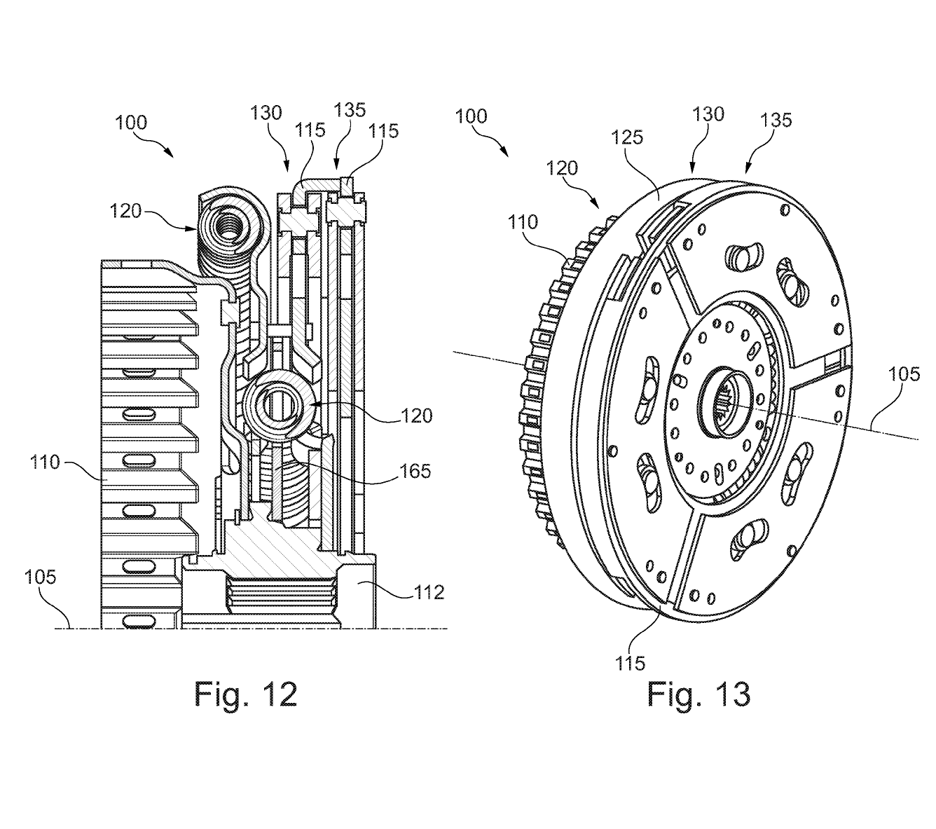

FIGS. 12 and 13 show a fourth embodiment of a torque transfer device 100 according to the embodiment of FIG. 3. The pendulum flanges 115, to which the pendulum masses 130 and 135 are attached, are connected to each other rigidly and are braced with respect to the drive element 110 by means of the radially outer second elastic element 120. The radially inner first elastic element 120 braces an intermediate mass 165 with respect to the pendulum flanges 115.

The first pendulum mass 130 is connected to the drive element 110 by means of the radially outer elastic element 120. At the same time, the pendulum flange 115 of the first pendulum mass 130 is frictionally engaged with an output element 112. The pendulum flange 115 of the second pendulum mass 135 is braced radially on the output element 112.

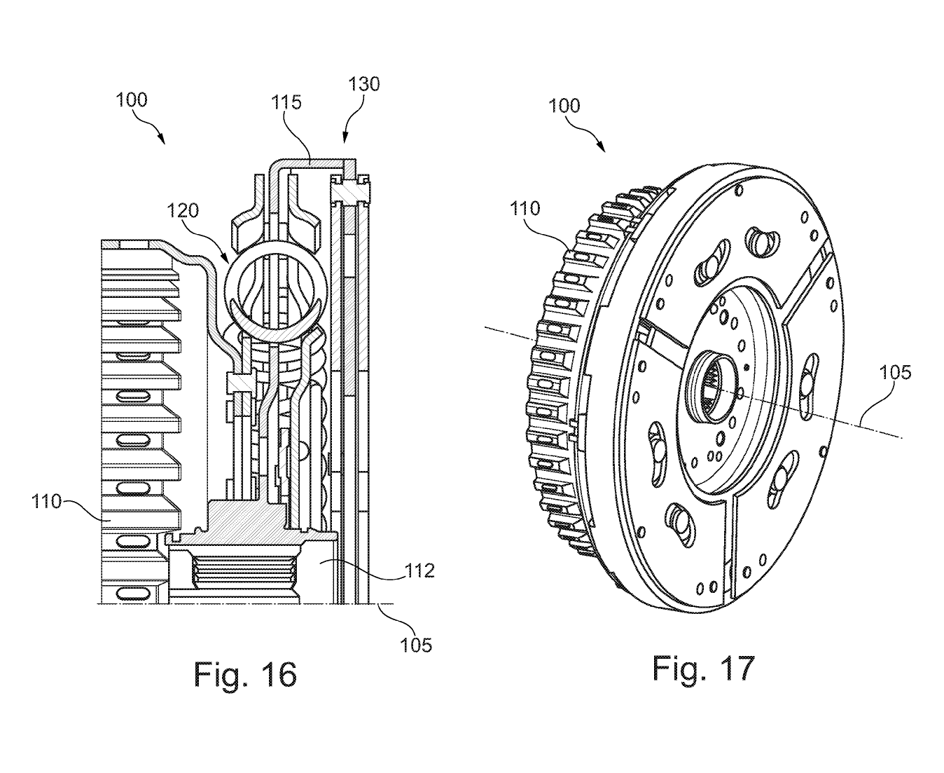

FIGS. 16 and 17 show a sixth embodiment of the torque transfer device 100 according to the embodiment of FIG. 1. There is only one pendulum flange 115 provided, which is formed as in the embodiment described in reference to FIG. 3. In this case, the pendulum flange 115 is connected to the output element 112. The input side 110 is coupled to the pendulum flange 115 by means of the elastic element 120.

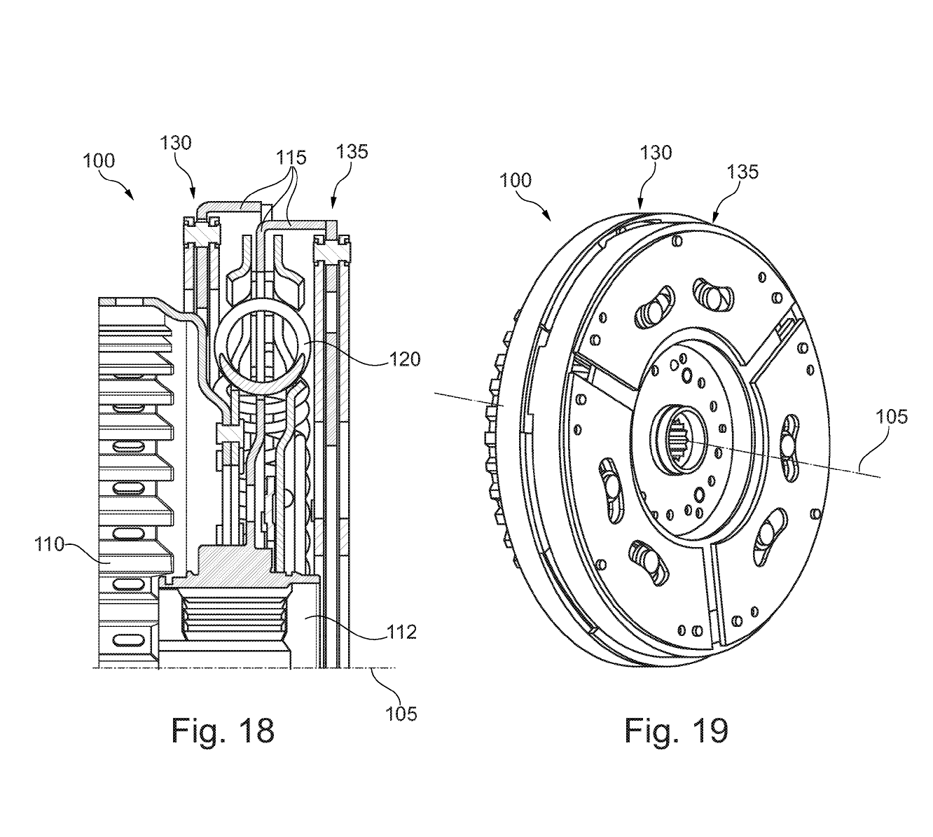

FIGS. 18 and 19 show a seventh embodiment of the torque transfer device 100 according to a variant similar to that of FIG. 4. The pendulum masses 130 and 135 are attached to pendulum flanges 115, which unite on a radially outer side to the connecting section 160, and from there run radially inward to the output element 112. The radially inward-running section of the pendulum flange 115 is braced with respect to the drive element 110 by means of the elastic element 120.

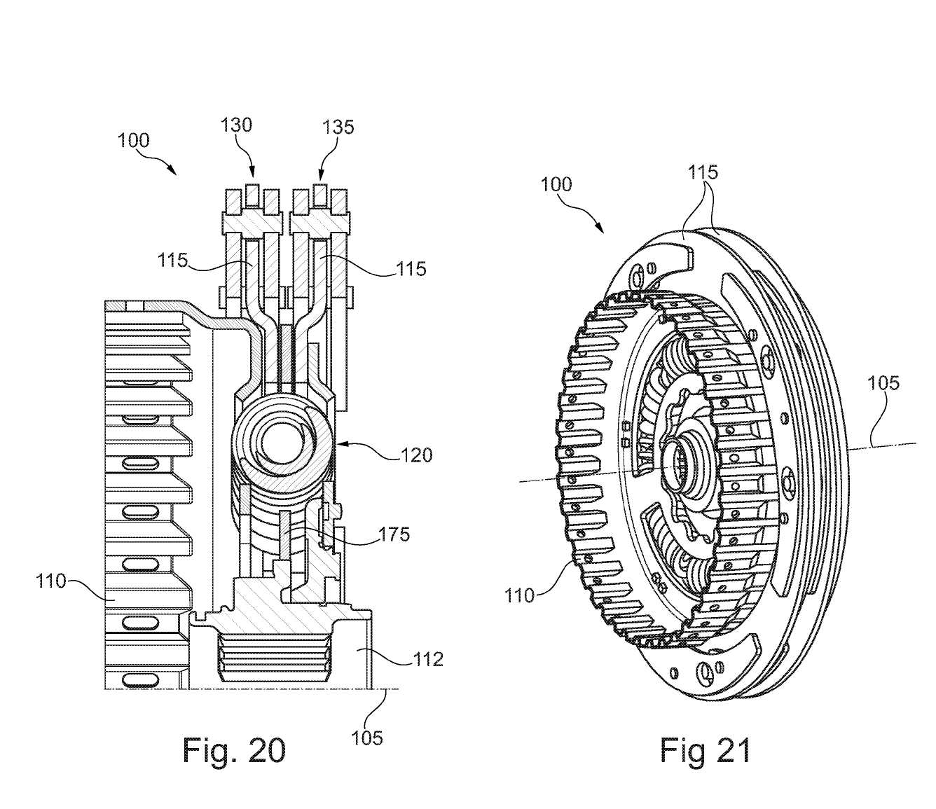

FIGS. 20 and 21 show an eighth embodiment of the torque transfer device 100 according to the variant of FIG. 4. The pendulum flanges 115 of the pendulum masses 130 and 135 are braced radially with respect to the output element 112 by means of a common elastic element 120. The drive element 110 is connected directly to the pendulum flanges 115 of the pendulum masses 130 and 135.

### REFERENCE LABELS

100 torque transfer device

102 centrifugal pendulum

105 axis of rotation

110 drive element

112 output element

115 pendulum flange

120 elastic element

125 damping element

130 first pendulum mass

135 second pendulum mass

140 first pendulum element

145 second pendulum element

150 first section

155 second section

160 connecting section

165 intermediate mass

175 hub flange

1-11. (canceled)

12. A torque transfer device comprising:
a drive element;
an output element;
an elastic element for coupling the drive element with the output element;
a pendulum flange connected to the output element;
a first pendulum mass attached movably in a plane of rotation to the pendulum flange; and
a second pendulum mass attached movably in a further or the plane of rotation to the pendulum flange;
wherein at least one of the first and second pendulum masses is matched to different orders of excitation of rotary motion of the drive element.

13. The torque transfer device as recited in claim 12 wherein one of the first and second pendulum masses comprises a first pendulum element and a second pendulum element, wherein the pendulum elements are each matchable to an order of excitation, independently of each other.

14. The torque transfer device as recited in claim 12 further comprising a second pendulum flange attached movably to the second pendulum mass in the or the further plane of rotation, where the second pendulum flange is attached rotatably in the or the further plane of rotation around the axis of rotation relative to the first pendulum flange and an elastic element is provided to couple the second pendulum flange with the first pendulum flange.

15. The torque transfer device as recited in claim 12 wherein sections of the pendulum flange to which he first and second pendulum masses are attached are offset axially.

16. The torque transfer device as recited in claim 15 wherein the sections include a first section, to which the first pendulum mass is attached, and a second section, to which the second pendulum mass is attached, the first and second sections frictionally engaged with each other on a radial outer side.

17. The torque transfer device as recited in claim 16 wherein the first and second sections fare fictionally engaged with each other on a radial inner side.

18. The torque transfer device as recited in claim 17 wherein a connecting section of the first and second sections is attached rotatably around the axis of rotation relative to the drive element and the elastic element is provided for coupling the connecting section to the drive element.

19. The torque transfer device as recited in claim 12 wherein the first and second pendulum masses are attached around the axis of rotation at equal effective radii.

20. The torque transfer device as recited in claim 12 wherein the first and second pendulum masses are attached around the axis of rotation at different effective radii.

21. The torque transfer device as recited in claim 12 wherein the first and second pendulum masses are designed for same orders of matching.

22. The torque transfer device as recited in claim 12 wherein the pendulum masses are designed for different orders of matching.
